(19) United States
(12) Patent Application Publication
(10) Pub. No.: US 2005/0084178 A1
(43) Pub. Date: Apr. 21, 2005

(54) Radiological image processing based on different views of temporal images

(76) Inventors: Fleming Y.-M. Lure, Potomac, MD (US); H.-Y. Michael Yeh, Potomac, MD (US); Jyh-Shyan Lin, North Potomac, MD (US); Xin-Wei Xu, Gaithersburg, MD (US)

Correspondence Address: VENABLE, BAETJER, HOWARD AND CIVILETTI, LLP, P.O. BOX 34385, WASHINGTON, DC, 20043-9998, US

(21) Appl. No.: 10/747,626

(22) Filed: Dec. 30, 2003

Related U.S. Application Data
(60) Provisional application No. 60/436,636, filed on Dec. 30, 2002.

(51) Int. Cl. H01J 35/10; H01J 35/26; H01J 35/24; H01J 35/28; G06K 9/32

(52) U.S. Cl. 382/294; 378/132

(57) ABSTRACT

A method of processing radiological images for diagnostic purposes involves the automated registration and comparison of images obtained at different times. A variation on the method may also use computer-aided detection (CAD) in conjunction with image parameters obtained during the process of registration to register CAD results.

### CROSS-REFERENCE TO RELATED APPLICATION

This application claims the benefit of U.S. Provisional Patent Application No. 60/436,636, entitled “Enhanced Lung Cancer Detection via Registered Temporal Images”, filed Dec. 30, 2002, the contents of which are incorporated by reference in their entirety.

### BACKGROUND AND SUMMARY OF THE INVENTION

An exemplary embodiment of the present invention relates generally to computer aided detection (CAD) of abnormalities and digital processing of radiological images, and more particularly to automatic image registration methods for sequential chest radiographs and sequential thoracic CT images of the same patient that have been acquired at different times. Registration (also known as matching) is the process of bringing two or more images into spatial correlation.

An important tool in the detection of cancers such as lung cancer is the clinical reading of chest X-rays. Conventional methods of reading X-rays, however, have a fairly high rate of missed detection. Studies investigating the use of chest radiographs for the detection of lung nodules (such as Stitik, 1985, and Heelan, 1984) have demonstrated that even highly skilled and highly motivated radiologists, task-directed to detect any finding of suspicion for a pulmonary nodule, and working with high quality radiographs, still fail to detect more than 30 percent of the lung cancers that can be detected retrospectively. In the two series reported separately by Stitik and Heelan, many of the missed lesions would be classified as TlNxMx lesions, a grouping of non-small cell lung cancer that C. Mountain (1989) has indicated has the best prognosis for survival (42%, 5 year survival).

Since the early 1990s, the volumetric computed tomography (CT) technique has introduced virtually contiguous spiral scans that cover the chest in a few seconds. Detectability of pulmonary nodules has been greatly improved with this modality [Zerhouni 1983; Siegelman 1986; Zerhouni 1986; Webb 1990]. High-resolution CT has also proved to be effective in characterizing edges of pulmonary nodules [Zwirewich 1991]. Zwirewich and his colleagues reported that shadows of nodule spiculation correlates pathologically with irregular fibrosis, localized lymphatic spread of tumor, or an infiltrative tumor growth; pleural tags represent fibrotic bands that usually are associated with juxtacicatrical pleural retraction; and low attenuation bubble-like patterns that are correlated with bronchioloalveolar carcinomas. These are common CT image patterns associated with malignant processes of lung masses. Because a majority of solitary pulmonary nodules (SPN) are benign, Siegleman and his colleagues (1986) determined three main criteria for benignancy: high attenuation values distributed diffusely throughout the nodule; a representative CT number of at least 164 Hounsfield Units (HU); and hamartomas are lesions 2.5 cm or less in diameter with sharp and smooth edges and a central focus of fat with CT number numbers of −40 to −120 HU.

In Japan, CT-based lung cancer screening programs have been developed [Tateno 1990; Iinuma 1992]. In the US, however, only a limited demonstration project funded by the NIH/NCl using helical CT has been reported [Yankelevitz 1999]. The trend toward using helical CT as a clinical tool for screening lung cancer addresses four foci: an alternative to the low sensitivity of chest radiography; the development of higher throughput low-dose helical CT; the potential cost reduction of helical CT systems; and the development of a computer diagnostic system as an aid for pulmonary radiologists.

Since the late 1990s, there has been a great deal of interest in lung cancer screening in the medical and public health communities. An exemplary embodiment of the present invention includes the use of a commercial computer-aided system (RapidScreen® RS-2000) for the detection of early-stage lung cancer, and provides further improvements in the detection performance of the RS-2000 and a CAD product developed for use with thoracic computed tomography (CT).

An exemplary embodiment of the present invention provides automatic image registration methods for sequential chest radiographs and sequential thoracic CT images of the same patient that have been acquired at different times, typically 6 months to one year apart, using, if possible, the same machine and the same image protocol.

An exemplary embodiment of the present invention is a high-standard CAD system for sequential chest images including thoracic CT and chest radiography. It is the consensus of the medical community that low-dose CT will serve as the primary image modality for the lung cancer screening program. In fact, the trend is to use low-dose, high-resolution CT systems, as recommended by several leading CT manufacturers and clinical leaders. Projection chest radiography will be included as a part of imaging protocol [Henschke 1999; Sone 2001].

Unlike a conventional CAD detection system that aims to detect round objects in the lung field, a method of the present invention in an exemplary embodiment looks at the problem from a different angle and concentrates on extracting and reducing the normal chest structures. By eliminating the unchanged lung structures and/or by comparing the differences between the temporal images with the computer-aided system, the radiologist can more effectively detect possible cancers in the lung field.

The method of the present invention in an exemplary embodiment uses various segmentation tools for extraction of the lung structures from images. The segmentation results are then used for matching and aligning the two sets of comparable chest images, using an advanced warping technique with a constraint of object size. While visual comparison of temporal images is currently used by radiologists in routine clinical practice, its effectiveness is hampered by the presence of normal chest structures. Through further technical advances incorporated in the method of the present invention in an exemplary embodiment, including lung structure modeling incorporated with image taking procedure, accurate registration has become possible. The applications of registered temporal images include: facilitating the clinical reading with temporal images; providing temporal change that is usually related to nodule (cancer) growth; and increasing computer-aided detection accuracy by reducing the normal chest structures and highlighting the growing patterns.

In an exemplary embodiment of the present invention, digitally registered chest images assist the radiologist both in the detection of nodule locations and their quantification (i.e., number, location, size and shape). This “expert-trained” computer system combines the expert pulmonary radiologist's clinical guidance with advanced artificial intelligence technology to identify specific image features, nodule patterns, and physical contents of lung nodules in 3D CT. Such a system can be a clinical supporting system for pulmonary radiologists to improve diagnostic accuracy in the detection and analysis of suspected lung nodules.

Clinically speaking, an accurate temporal subtraction image is capable of presenting changes in lung abnormality. The change patterns in local areas are clinically significant signs of cancer. Many of these are missed in conventional practice due to overlap with normal chest structures or are overlooked when the cancers are small. Several investigators have shown that the temporal subtraction technique can reveal lung cancers superimposed with radio-opaque structures and small lung cancers with extremely low contrast [See Section C; Difazio 1997; Ishida 1999]. Non-growing structures are usually not of clinical concern for lung cancer diagnosis. However, these structures can result in suspected cancer in conventional clinical practice with the possible consequence of sending patients for unnecessary diagnostic CTs. Use of a temporal subtraction image can eliminate the majority of non-growing structures.

The computer processing tools of an exemplary embodiment of the present invention register the rib cage in chest radiography and major lung structures in temporal CT image sets. The results enhance changes occurring between two temporally separated images to facilitate clinical diagnosis of the images. A computer-aided diagnosis (CAD) system identifies the suspected areas based on the subtraction image.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIG. 1 depicts an exemplary embodiment of the system of the present invention;

FIG. 2 depicts an exemplary embodiment of the overall method of registration according to the present invention;

FIG. 3 depicts an exemplary embodiment of the methods of creating an image set from CT slices according to the present invention;

FIG. 4 depicts an exemplary embodiment of the detailed method of registration and temporal comparison of two chest images according to the present invention;

FIG. 5 depicts an exemplary embodiment of the detailed method of local anatomic region registration according to the present invention;

FIG. 6 depicts an exemplary embodiment of the method of landmark registration;

FIG. 7 depicts an exemplary embodiment of the method for quick slice matching; and

FIG. 8 depicts an exemplary implementation of an embodiment of the invention.

### DESCRIPTION OF VARIOUS EMBODIMENTS OF THE INVENTION

Embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

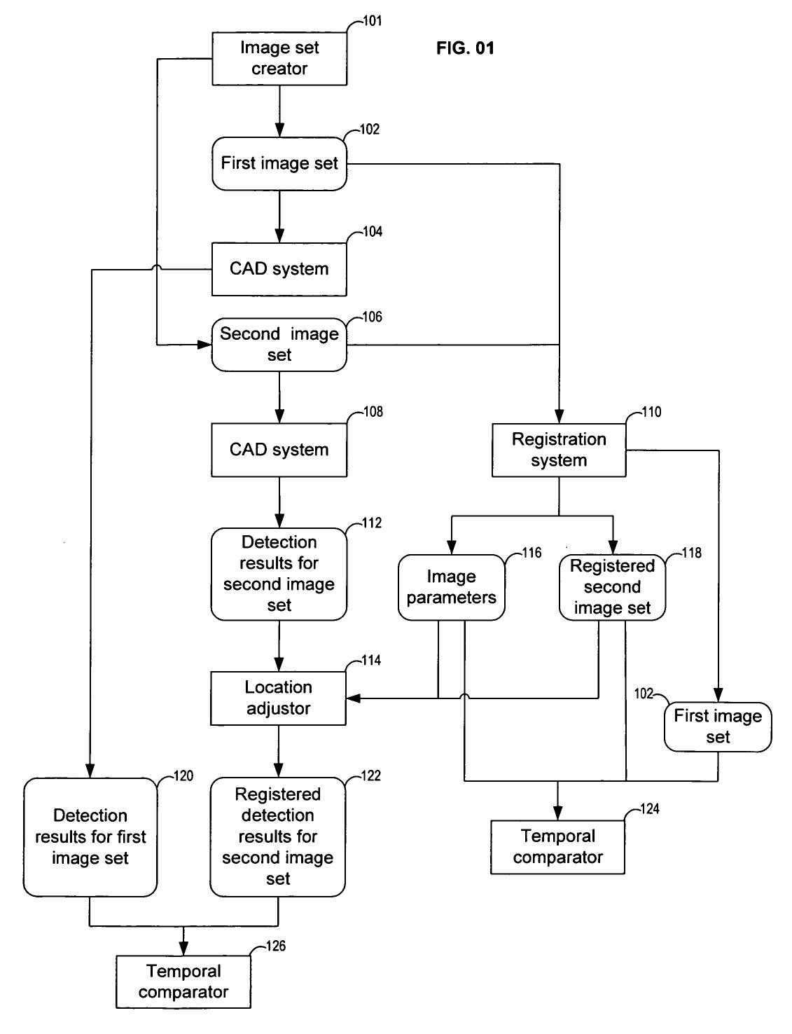

FIG. 1 depicts an exemplary embodiment of a system of the present invention. In particular, it shows two semi-independent process flows that each leads to the temporal comparison of a pair of image sets. The image set creator 101 can create image sets directly from CT X-Ray or other image acquisition systems or other image processing systems. The first axial-view image set 102 is sent both to a CAD system or multiple CAD systems 104 and to a registration system 110. The second axial-view image set 106 is sent both to a CAD system or multiple CAD systems 108 (not necessarily the same CAD system or multiple CAD systems as the first image set) and to the same registration system 110. The CAD system 104 produces nodule detection results for the first image set 120, and the CAD system 108 produces nodule detection results for the second image set 112. In one process flow for temporal comparison, the registration system 110 outputs registered images for the second image set 118 and transformation parameters for the second image set 116, along with the original first image set 102, which are then compared 124, either by a human or by a computer. In the other process flow for temporal comparison, the registered images for the second image set 118 and the transformation parameters for the second image set 116 are sent to the location adjuster 114. The location adjuster 114 outputs registered nodule detection results for the second image set 122, which are then compared 126 with the nodule detection results for the first image set 120, either by a human or by a computer.

Following is a more detailed description of the role of the location adjuster 114: The registration system 110 shifts the images in the second image set 106 to produce the registered second image set 118. The transformation parameters for the second image set 116 are a numerical matrix that describes the shift of the images in the second image set 106, relative to the first image set 120, as performed by the registration system 110. These image parameters 116 may be obtained in one of many known or as yet to be discovered ways. The location adjuster 114 multiplies the detection results for the second image set 112 by the transformation parameters for the second image set 116. The results of the multiplication performed by the location adjuster 114 are the registered detection results for the second image set 122.

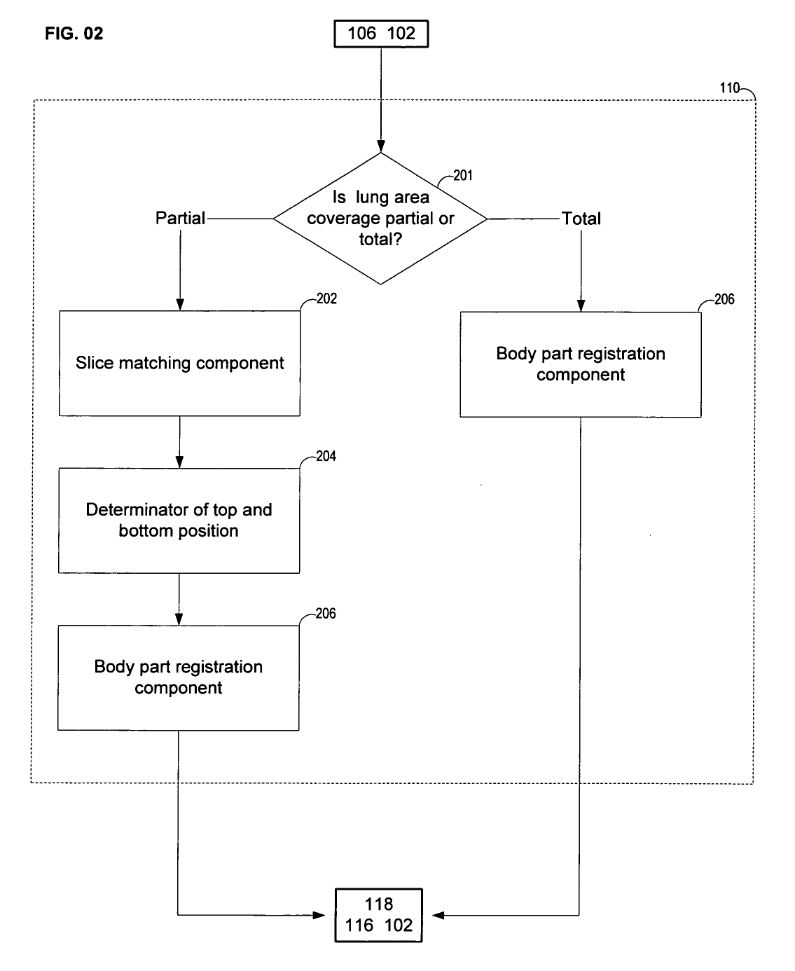

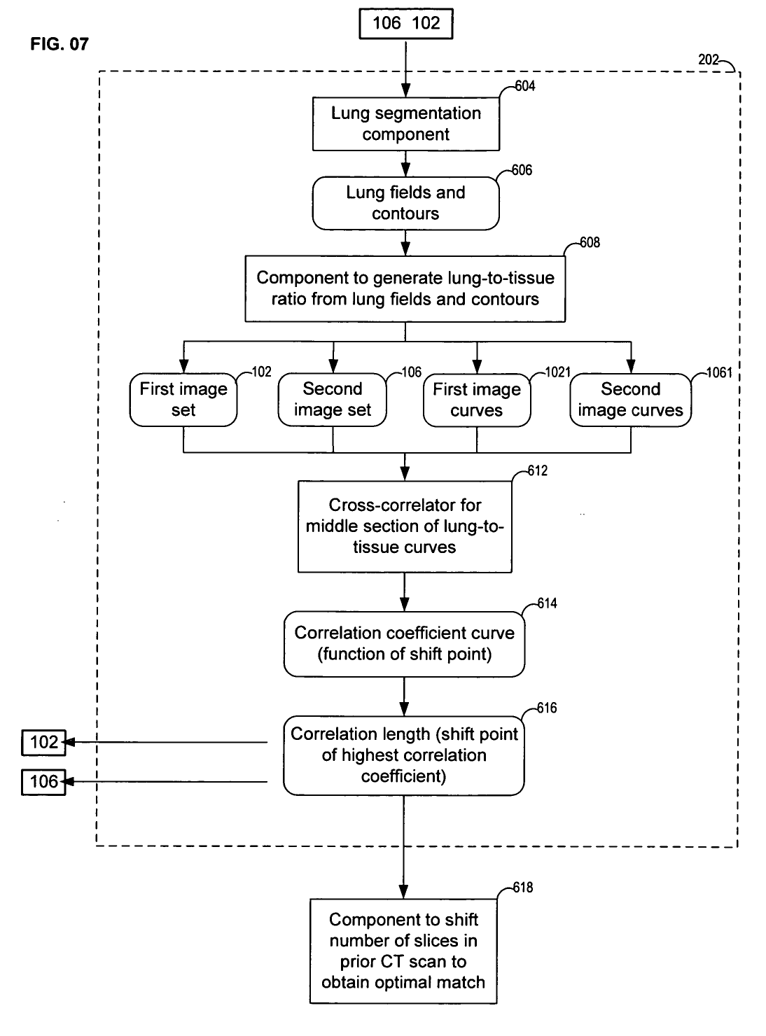

FIG. 2 depicts a detailed version of the registration system 110. When first image set 102 and the second image set 106 enter the registration system 110, the registration system 110 first determines if the lung area coverage of the second image set is partial or total 201. If coverage is partial, the second image set undergoes slice matching 202 (slice matching 202 is discussed further in relation to FIG. 7). This is followed by a determination of the top and bottom of the lung in the images 204, followed by body part registration 206. On the other hand, if it is determined that the lung area coverage of the second image set is total, the second image set immediately undergoes body part registration 206. The output of the registration system is the registered images for the second image set 118 and transformation parameters for the second image set 116, along with the original first image set 102.

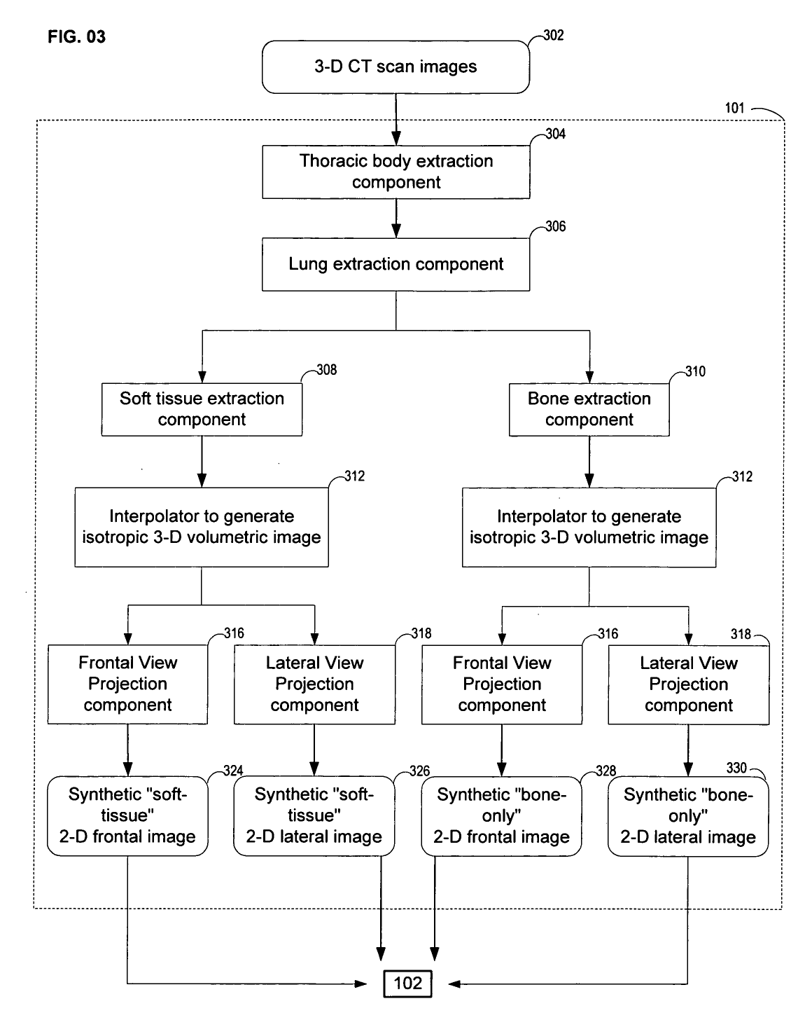

FIG. 3 depicts a detailed version of only one example of image set creation 101, in this case from 3-D CT scans acquired from an imaging system. In this example, thoracic body extraction 304 and lung extraction 306 are performed on either a 2-dimensional area or 3-dimensional volume 302. Soft tissue extraction 308 and bone extraction 310 are performed separately. The interpolator 312 generates isotropic, 3-dimensional, volumetric images separately for the extracted soft tissue and bone.

When performing 2-D slice-by-slice processing, 2-D interpolation is applied on the image pixels in each axial-view slice (based on the slice thickness) such that the image pixel size has an aspect ratio of one. When performing 3-D volume processing, 3-D interpolation is applied on the 3-D volume data such that each voxel has isotropic voxel size.

Frontal 316 and lateral 318 view projection components each process the soft-tissue and bone volumetric images separately. The following four views are then generated: a synthetic, soft-tissue, 2-D frontal view 324 from the soft-tissue frontal view projection; a synthetic, soft-tissue, 2-D lateral view 326 from the soft-tissue lateral view projection; a synthetic, bone-only, 2-D frontal view 328 from the bone-only frontal view projection; and a synthetic, bone-only, 2-D lateral view 330 from the bone-only lateral view projection.

In an exemplary embodiment, the method of the present invention can be generalized to create synthetic views of any projection angles with preferred bone-only, soft-tissue, and/or lung-tissue images or volumes. The synthesized 2-D images or 3-D volume can be used to help either physicians or a computer-aided detection/diagnosis system in the detection of abnormalities from different views at different angles. For example, a computer-aided detection/diagnosis system can be applied on the software-tissue images or volume rather than on synthetic original frontal or lateral view images or volume to detect abnormalities. Since there are no bones or rib-crossings in the soft-tissue images or volume, the performance of detecting abnormalities can be greatly improved. Furthermore, the bone-only images or volume can be used to determine whether a detected abnormality is calcified.

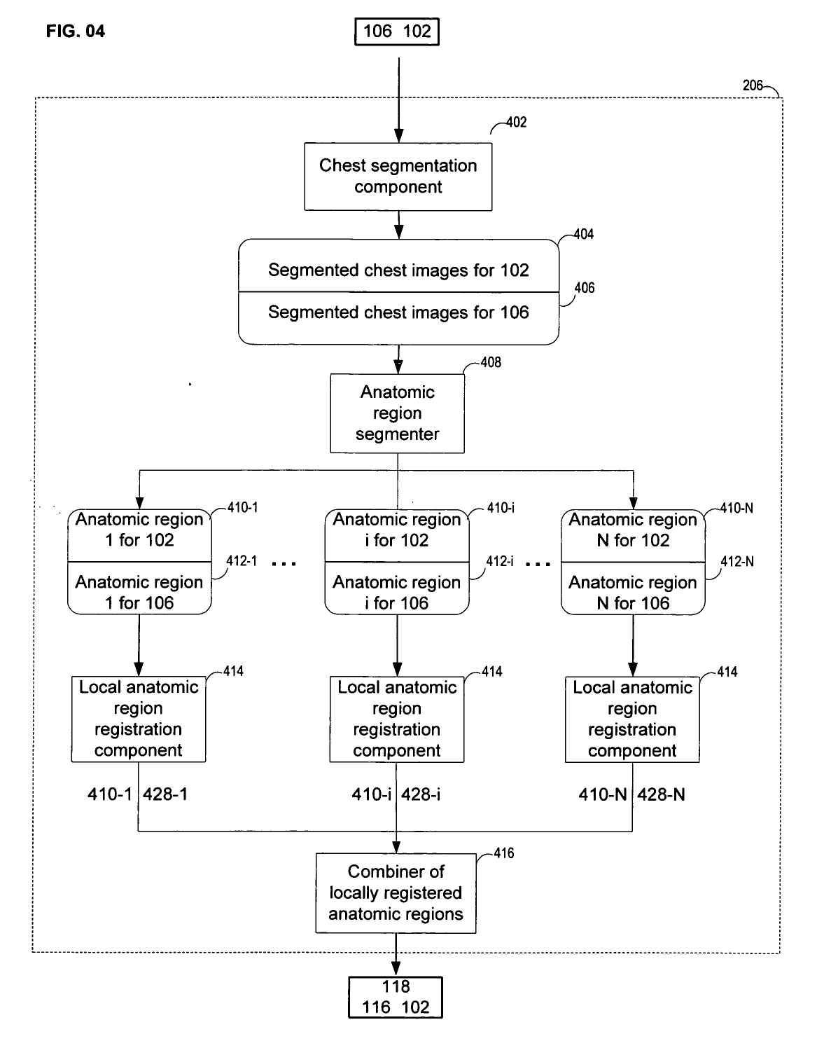

FIG. 4 depicts a more detailed view of the registration and temporal comparison of two chest images. The first image set 102 and the second image set 106 are received by the body part registration component 206, which performs chest segmentation 402 on the two image sets, yielding segmented chest images for the first image set 404 and segmented chest images for the second image set 406. An anatomic region segmenter 408 divides each CT scan into N anatomic regions, yielding a pair of image sets for each anatomic region of each of the original two image sets: The image sets for anatomic region i for the first image set 410-i and the image sets for anatomic region i for the second image set 412-i. (An anatomic region is a subdivision of the image volume, as opposed to a specific organ.)

The local anatomic region registration component 414 takes the image sets for anatomic region i for the first image set 410-i and the image sets for anatomic region i for the second image set 412-i and performs registration on each 412-i, yielding the registered anatomic region i for the second image set 428-i, which is passed on along with the image sets for anatomic region i for the first image set 410-i to the combiner of locally registered anatomic regions 416. The combiner 416 reverses the process of anatomic region segmentation by using geometric tiling to combine all the regions into a whole chest image. The output of the combiner 416 is the registered images for the second image set 118 and the transformation parameters for the second image set 116, along with the original first image set 102.

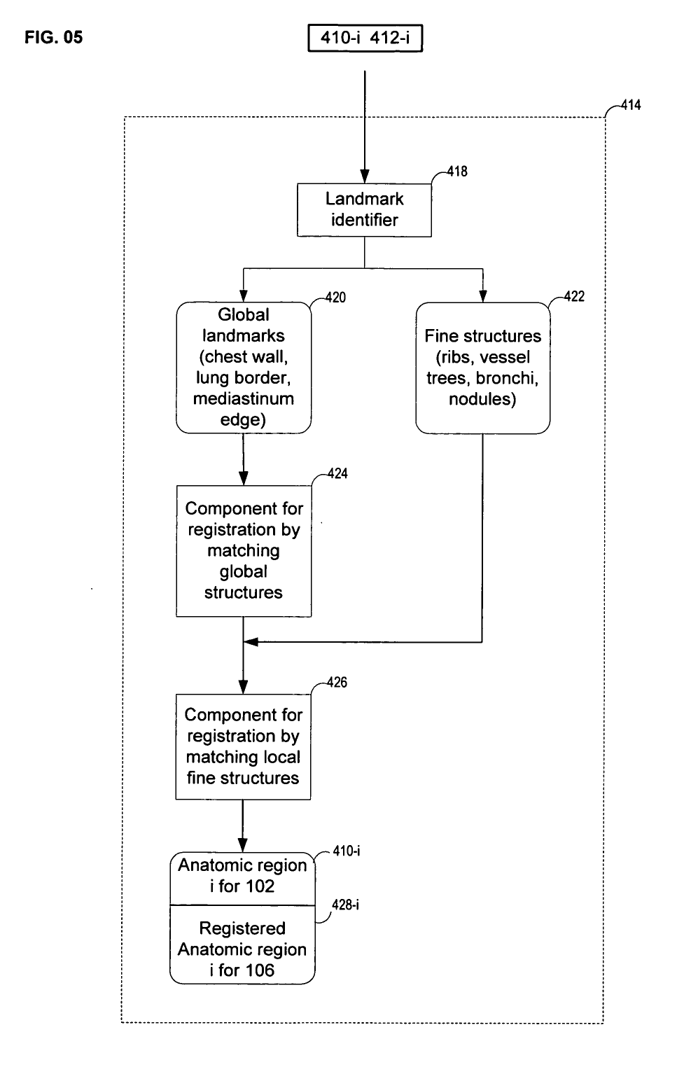

FIG. 5 depicts a more detailed view of the local anatomic region registration component 414. The landmark identifier 418 identifies global landmarks such as the chest wall, lung border, and mediastinum edge 420 separately from fine structures such as ribs, vessel trees, bronchi, and small nodules 422. The component for registration by matching global structures 424 matches the identified global landmarks 420 (lung fields), and then the component for registration by matching local fine structures 426 matches the identified fine structures 422. The component for registration by matching global structures 424 can refer to the techniques found in “Computer Aided Diagnosis System for Thoracic CT Images,” U.S. patent application Ser. No. 10/214,464, filed Aug. 8, 2002, which is incorporated by reference, or any other registration method. The output of the local anatomic region registration component is the registered anatomic region i for the second image set 428-i, along with the image sets for anatomic region i for the first image set 410-i.

An image-warping method using a projective transformation [Wolberg 1990] for the registration of chest radiographs can also be used. The projective transformation from one quadrilateral to another quadrilateral area is worth evaluating for its lower level of computation complexity with the potential for similarly satisfactory outcomes.

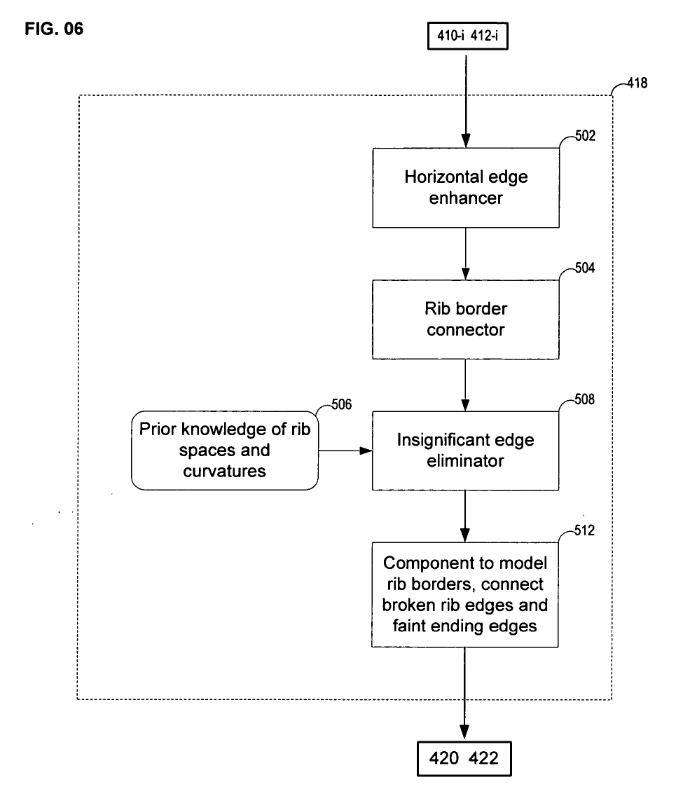

FIG. 6 depicts one example of a landmark identifier 418. First, horizontal edges are enhanced 502 and rib borders are connected 504. Insignificant edges are eliminated 508 by employing prior knowledge of rib spaces and their curvatures 506. Rib borders are modeled and broken rib edges and faint ending edges are connected as necessary 512. More information about this method can be found in U.S. patent application Ser. No. 09/625,418, filed Jul. 25, 2000, which issued on Nov. 25, 2003 as U.S. Pat. No. 6,654,728, entitled “Fuzzy Logic Based Classification (FLBC) Method for Automated Identification of Nodules in Radiological Images,” which is incorporated by reference.

When one CT scan covers only a small portion of the lung, slice matching must be applied 202. It is time-consuming for radiologists to compare current and prior (temporally sequential) thoracic CT scans to identify new findings or to assess the effects of treatments on lung cancer, because this requires a systematic visual search and correlation of a large number of images between both current and prior scans. A sequence-matching process automatically aligns thoracic CT images taken from two different scans of the same patient. This procedure allows the radiologist to read the two scans simultaneously for image comparison and for evaluation of changes in any noted abnormalities.

Automatic sequence matching involves quick slice matching and accurate volume registration. FIG. 7 depicts an exemplary embodiment of the method of the present invention for quick slice matching 202. The first image set 102 and the second image set 106 are processed by lung segmentation 604 to obtain the lung field and its contour (boundary) 606. A parameter called lung-to-tissue ratio, defined as the ratio of the number of pixels in the lung region to the number in the remaining tissue image in that section, is generated 608. A curve corresponding to a series of lung-to-tissue ratios is also generated for both image sets: The curve for the first image set 102 is 1021 and the curve for the second image set 106 is 1061. A cross-correlation technique is applied to the middle section of the two curves 612 to determine the correlation coefficient curve as a function of shift point 614. The shift point corresponding to the highest correlation coefficient is used to define the corresponding correlation length 616. The first image set 102 and the second image set 106 are released for further processing. The optimal match is obtained by shifting the number of slices in the prior CT scan according to the correlation length 618, which represents the number of slices mismatched between two CT scans. This process is more robust when comparing two full-lung CT scans than when comparing one full-lung CT scan with one partial-lung CT scan.

Following is a more detailed view of the process to obtain the correlation length:

A CT scan A consists of N slices, while another CT scan B consists of M slices. The chest in each slice can be separated into the lung region (primary air) and tissue region (tissue and bone). For each slice, one can compute the area of the lung and tissue regions and obtain a single value for the ratio of lung area over tissue area in that slice. Scan A has N points, which form a curve (curve A) of N points. Scan B has M points, which form a curve (curve B) of M points. The horizontal axis is the slice number (index) and the vertical axis is the ratio. The horizontal axis corresponds to the location of the slice within the lung. A standard correlation process is to move one curve alongside the other and multiply their values. This “moving and multiplication” generate a new curve called the correlation curve. The horizontal axis of the correlation curve is the shift (slice number or length of the lung), where each point on the horizontal axis may be termed a “shift point,” and the vertical axis is the correlation coefficient. By an additional standard process, the shift S in the correlation curve corresponding to the maximum correlation coefficient is the slice shift between scan A and scan B and may be termed the. “correlation length,” as discussed above. In other words, one can shift scan A by S to obtain the best match between scan A and B.

Following is an exemplary embodiment of the method of the present invention for registration using a volumetric approach. First, the lung contour of two CT volume sets is delineated. An iterative closest point (ICP) process is applied to these corresponding contours with least-squares correlation as the main criterion. This ICP process implements rigid-body transformation (six degrees of freedom) by minimizing the sum of the squares of the distance between two sets of points. It finds the closest contour voxel within a set of CT scans for every given voxel from another set of CT scans. The pair of closest (or corresponding) voxels is then used to compute the optimal parameters for rigid-body transformation. The quaternion solution method can be used for finding the least-squares registration transformation parameters, since it has the advantage of eliminating the reflection problem that occurs in the singular value decomposition approach.

The first step in this quaternion solution method requires a set of initial transformation parameters to determine a global starting position. This information is obtained from the previous slice-matching step, and then the center of mass (centroid) of the initial image positions is used for an iterative matching process. During each iteration, every surface voxel inside the second volume is transformed according to the current transformation matrix for searching the closest voxel within the first volume. This search is repeated on the first volume again to search for the second volume. Where there is no surface voxel at the same location on the other volume, the search is continued in the neighboring voxel in each direction until it reached a pre-defined distance.

After the initial process of searching for the closest voxels, the corresponding voxel pairs are used to compute the optimal unit quaternion rotation parameters. With this method, the translation parameters are found using the difference between the centroids of two images after the rotation. These parameters formed an orthonormal transformation matrix for the next iteration. This process is repeated until the root mean square error between two closest voxels reaches a pre-defined value. Once the iterative matching is completed, the transformation matrix is then applied to re-slice (or transform) the second CT image according to the first CT image's geometrical position in 3D. One may refer, for example, to the aforementioned U.S. Patent Application, “Computer Aided Diagnosis System for Thoracic CT Images,” for an exemplary embodiment of the CAD systems 104 and 108.

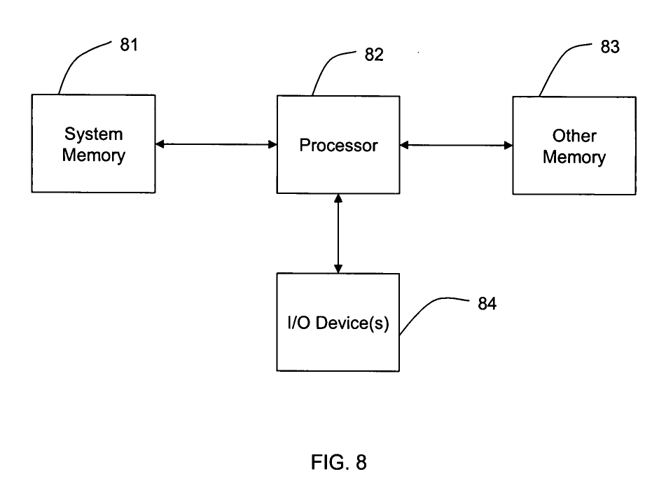

Some embodiments of the invention, as discussed above, may be embodied in the form of software instructions on a machine-readable medium. Such an embodiment is illustrated in FIG. 8. The computer system of FIG. 8 may include at least one processor 82, with associated system memory 81, which may store, for example, operating system software and the like. The system may further include additional memory 83, which may, for example, include software instructions to perform various applications. The system may also include one or more input/output (I/O) devices 84, for example (but not limited to), keyboard, mouse, trackball, printer, display, network connection, etc. The present invention may be embodied as software instructions that may be stored in system memory 81 or in additional memory 83. Such software instructions may also be stored in removable or remote media (for example, but not limited to, compact disks, floppy disks, etc.), which may be read through an I/O device 84 (for example, but not limited to, a floppy disk drive). Furthermore, the software instructions may also be transmitted to the computer system via an I/O device 84, for example, a network connection; in such a case, a signal containing the software instructions may be considered to be a machine-readable medium.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

1. A method of processing radiological images, comprising:
registering first and second different radiological image sets, said first and second radiological image sets being obtained from a common portion of a common subject to generate a registered second radiological image set and a set of image parameters of said second radiological image set, the image parameters describing a shift of said second radiological image set relative to said first radiological image set; and
performing a temporal comparison using said image parameters, said registered second radiological image set, and said first radiological image set.

2. The method according to claim 1, wherein said registering comprises:
performing body part registration.

3. The method according to claim 2, wherein said registering further comprises:
performing the following steps, prior to said body part registration, if the second set of radiological images only partially covers an area under consideration:
performing slice matching of said second set of radiological images, relative to said first set of radiological images; and
determining top and bottom positions of said second set of radiological images.

4. The method according to claim 3, wherein said slice matching comprises:
determining a correlation length between said first and second sets of radiological images; and
shifting one of said sets of radiological images relative to the other.

5. The method according to claim 4, wherein said common portion comprises a lung region, and wherein said determining a correlation length comprises:
performing lung segmentation on each of said first and second sets of radiological images to determine lung fields and contours of said first and second sets of radiological images;
for each of said first and second sets of radiological images, generating values of a lung-to-tissue ratio for a multiplicity of regions, based on said lung fields and contours, to produce first and second lung-to-tissue ratio curves corresponding to said first and second sets of radiological images;
cross-correlating at least a portion of each of said first and second lung-to-tissue ratio curves to obtain a correlation curve; and
determining said correlation length based on said correlation curve.

6. The method according to claim 5, wherein said determining said correlation length comprises:
determining a maximum value of said correlation curve and determining said correlation length to be a shift corresponding to said maximum value.

7. The method according to claim 2, wherein said body part registration comprises:
segmenting said first and second sets of radiological images to produce first and second sets of segmented radiological images;
registering at least one segmented anatomic region of said second set of segmented radiological images with said first set of segmented radiological images to produce a registered second set of segmented radiological images; and
combining said registered second set of segmented radiological images to produce said registered radiological image set and said image parameters.

8. The method according to claim 7, wherein said segmenting further comprises:
performing an anatomic region segmentation on said first and second sets of segmented radiological images to produce first and second sets of anatomic region image segments.

9. The method according to claim 8, wherein said registering comprises:
registering corresponding anatomic region image segments from said first and second sets of anatomic region image segments.

10. The method according to claim 9, wherein said registering corresponding anatomic region image segments comprises:
identifying anatomical landmarks in said first and second sets of anatomic region image segments;
classifying each anatomical landmark as a global landmark or as a fine structure; and
matching at least one of said global landmarks.

11. The method according to claim 10, wherein said registering corresponding anatomic region image segments further comprises:
matching at least one of said fine structures.

12. The method according to claim 10, wherein said identifying anatomical landmarks comprises:
performing edge enhancement;
performing border connection;
eliminating insignificant edges; and
enhancing remaining edges.

13. The method according to claim 1, further comprising:
applying at least one computer-aided detection (CAD) system to each of said first and second radiological image sets to produce first and second detection results, respectively;
performing location adjustment on said second detection results, using said image parameters, to produce registered second detection results; and
temporally comparing said first detection results and said registered second detection results.

14. The method according to claim 1, further comprising:
generating said first and second sets of radiological images.

15. The method according to claim 11, wherein said common portion comprises a lung region and wherein said generating comprises, for each of said first and second sets of radiological images:
extracting a thoracic body region from a set of three-dimensional computer tomograpy (CT) images;
extracting a lung region from said thoracic body region;
separately extracting soft tissue regions and bone regions from said lung region; and
separately interpolating said soft tissue regions and said bone regions to produce interpolated soft tissue regions and bone regions; and
performing frontal and lateral view projections on each of said interpolated soft tissue regions and bone regions.

16. A computer-readable medium containing software code that, when executed by a computing platform, causes the computing platform to perform the method according to claim 1.

17. The method according to claim 16, wherein said registering comprises:
performing body part registration.

18. The method according to claim 17, wherein said registering further comprises:
performing the following steps, prior to said body part registration, if the second set of radiological images only partially covers an area under consideration:
performing slice matching of said second set of radiological images, relative to said first set of radiological images; and
determining top and bottom positions of said second set of radiological images.

19. The method according to claim 16, further comprising:
applying at least one computer-aided detection (CAD) system to each of said first and second radiological image sets to produce first and second detection results, respectively;
performing location adjustment on said second detection results, using said image parameters, to produce registered second detection results; and
temporally comparing said first detection results and said registered second detection results.

20. A computer system adapted to perform the method according to claim 1.

21. A system for processing radiological images, comprising:
an image registration component adapted to receive first and second sets of radiological images obtained from a common portion of a common subject, the image registration system adapted to produce a registered second set of radiological images and a set of image parameters describing a shift of said second set of radiological images relative to said first set of radiological images; and
a temporal comparator adapted to receive said first set of radiological images, said registered second set of radiological images, and said image parameters and to perform a comparison between said first set of radiological images and said second set of radiological images.

22. The system according to claim 21, further comprising:
a slice-matching component adapted to receive said second set of radiological images and to perform slice matching of said second set of radiological images relative to said first set of radiological images; and
a top and bottom determiner adapted to determine top and bottom positions of said second set of radiological images.

24. The system according to claim 21, wherein said image registration component comprises:
a segmentation component adapted to segment said first and second sets of radiological images to produce first and second sets of segmented radiological images;
a registration component adapted to register at least one segmented anatomic region of said second set of segmented radiological images with said first set of segmented radiological images to produce a registered second set of segmented radiological images; and
a combiner adapted to combine said registered second set of segmented radiological images to produce said registered radiological image set and said image parameters.

25. The system according to claim 24, wherein said segmentation component is further adapted to perform anatomic region segmentation on said first and second sets of segmented radiological images to produce first and second sets of anatomic region image segments.

26. The system according to claim 25, wherein said registration component is further adapted to register corresponding anatomic region image segments from said first and second sets of anatomic region image segments.

27. The system according to claim 21, further comprising:
at least one computer-aided diagnosis (CAD) system adapted to process said first set of radiological images and said second set of radiological images to produce first and second detection results, respectively;
a location adjustor adapted to receive said second detection results and to receive said image parameters, the location adjustor applying said image parameters to said second detection results to produce registered second detection results; and
a temporal comparator adapted to receive and to compare said first detection results and said registered second detection results.

28. The system according to claim 27, further comprising:
means for generating said first and second sets of radiological images.
